(19) United States
(12) Patent Application Publication
(10) Pub. No.: US 2025/0308416 A1
(43) Pub. Date: Oct. 2, 2025

(54) MODE SWITCHING METHOD FOR PROJECTOR

(71) Applicant: SEIKO EPSON CORPORATION, Tokyo (JP)

(72) Inventors: Kentaro IDE, SHIOJIRI-SHI (JP); Masataka MIYAMOTO, MATSUMOTO-SHI (JP); Eisuke SAKAMOTO, MATSUMOTO-SHI (JP); Kohei SUZUKI, MATSUMOTO-SHI (JP)

(21) Appl. No.: 19/083,572

(22) Filed: Mar. 19, 2025

(30) Foreign Application Priority Data
Mar. 26, 2024 (JP) 2024-050215

(51) Int. Cl. G09G 3/00; G06F 3/14; G09G 5/00; H04N 21/4363

(52) U.S. Cl. CPC G09G 3/002; G06F 3/1454; G09G 5/006; H04N 21/43635; G09G 2354/00; G09G 2370/06; G09G 2370/12; G09G 2370/22

(57) ABSTRACT

A projector 100 acquires application information for identifying a coupling APP 245 that operates in an information processing device 200 from the information processing device 200, and switches, based on the acquired application information, an operation mode of the projector 100 to a PJ interactive mode in which operation information of an operation received by the projector 100 is processed by the projector or a PC interactive mode in which the operation information is transmitted to the information processing device 200 via a data communication line.

The present application is based on, and claims priority from JP Application Serial Number 2024-050215, filed Mar. 26, 2024, the disclosure of which is hereby incorporated by reference herein in its entirety.

### BACKGROUND

### 1. Technical Field

The present disclosure relates to a mode switching method for a projector.

### 2. Related Art

In the related art, a projector including a PJ interactive mode in which operation information received by the projector is processed by the projector and a PC interactive mode in which the operation information is processed by an external PC has been known.

For example, a display device disclosed in JP-A-2018-004681 can switch and execute an operation mode of outputting position information and an operation mode of performing drawing on a display surface based on the position information.

However, it is necessary for a user to manually switch the operation modes of the projector, which is troublesome for the user. It may be difficult for a user who is not familiar with the operation of the projector to switch the operation modes.

### SUMMARY

An aspect of the present disclosure is a mode switching method for a projector configured to project an image onto a projection surface, and the mode switching method includes: detecting, by the projector, that an information processing device is coupled to a coupler included in the projector; acquiring, by the projector, application information for identifying an application program that operates in the information processing device from the information processing device; and switching, based on the application information, an operation mode of the projector to a first operation mode in which operation information on an operation received by the projector is processed by the projector or a second operation mode in which the operation information is transmitted to the information processing device via a data communication line.

### BRIEF DESCRIPTION OF THE DRAWINGS

FIG. 1 is a diagram illustrating system configuration of a projection system.

FIG. 2 is a block diagram illustrating a configuration of a projector.

FIG. 3 is a block diagram illustrating a configuration of an information processing device.

FIG. 4 is a block diagram illustrating a configuration of an information processing device.

FIG. 5 is a flowchart illustrating operations of the projector and the information processing device at the time of coupling.

FIG. 6 is a flowchart illustrating operations of the projector at the time of source switching.

FIG. 7 is a flowchart illustrating operations of a projector and an information processing device according to a second embodiment.

FIG. 8 is a block diagram illustrating a configuration of a projector according to a third embodiment.

FIG. 9 is a block diagram illustrating a configuration of an information processing device according to the third embodiment.

FIG. 10 is a flowchart illustrating operations of the projector and the information processing device according to the third embodiment.

### DESCRIPTION OF EMBODIMENTS

### 1. System Configuration of Projection System

Hereinafter, embodiments according to the present disclosure will be described with reference to the accompanying drawings.

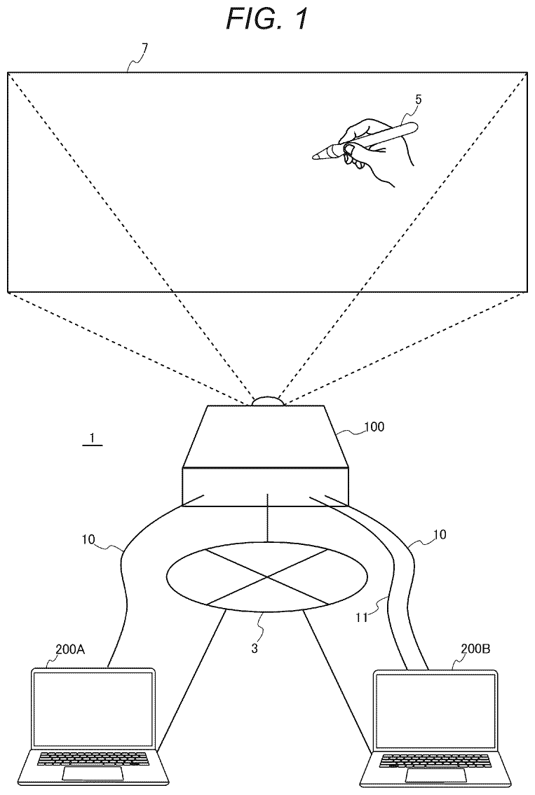

FIG. 1 is a diagram illustrating a system configuration of a projection system 1.

The projection system 1 includes a projector 100 that displays an image on a projection surface 7 and an information processing device 200 serving as a source. Although FIG. 1 illustrates two information processing devices 200, i.e., an information processing device 200A and an information processing device 200B, the number of information processing devices 200 coupled to the projector 100 may be three or more.

The projector 100 and the information processing devices 200A and 200B are coupled via a communication network 3. The communication network 3 corresponds to a data communication line.

Examples of the communication network 3 include a local area network (LAN) and a wide area network (WAN).

FIG. 1 illustrates an example in which the projector 100 and the information processing devices 200A and 200B are coupled to the communication network 3 by wire, but the projector 100 and the information processing devices 200A and 200B may be coupled to the communication network 3 by wireless communication such as Wi-Fi. Wi-Fi is a registered trademark.

The projector 100 and the information processing devices 200A and 200B are coupled via image cables 10. Examples of the image cable 10 include an HDMI cable and a display port cable. HDMI is a registered trademark. In the embodiment, a case where the projector 100 and the information processing devices 200A and 200B are coupled by the HDMI image cables 10 will be described.

The projector 100 generates image light based on image data included in an image signal supplied from the information processing device 200. The projector 100 projects the generated image light on the projection surface 7. Accordingly, an image corresponding to the image data is displayed on the projection surface 7.

The projector 100 and the information processing device 200B are coupled via an operation information transfer cable 11. Examples of the operation information transfer cable 11 include a USB cable. USB is a registered trademark. In the embodiment, a case where the projector 100 and the information processing device 200B are coupled by the USB operation information transfer cable 11 will be described.

The projector 100 detects an operation of an indicator 5 on the projection surface 7 and displays a line image at a position of the projection surface 7 where the operation is detected. In the embodiment, a case where the indicator 5 is an electronic pen will be described. The indicator 5 includes a light emitter that emits infrared light and a pressing detector that detects pressing of a tip end of the indicator 5 against the projection surface 7, that is, a touch on the projection surface 7. Examples of the pressing detector include a pressure-sensitive switch. Illustration of the light emitter and the pressing detector is omitted. The light emitter repeats blinking in a predetermined light emission sequence while the indicator 5 is operating. The light emitter changes the light emission sequence according to whether there is a touch on the projection surface 7. Therefore, the projector 100 can identify the presence or absence of the touch by the indicator 5 based on the light emission sequence of the light emitter.

The projector 100 includes an image-capturing unit 160 whose angle of view is adjusted such that an image of at least a part of the projection surface 7 can be captured. The projector 100 detects the light emitted by the indicator 5 from a captured image of the image-capturing unit 160, and detects a position of the detected light as an indication position indicated by the indicator 5. The projector 100 detects the presence or absence of a touch on the projection surface 7 based on a light emission sequence of the detected light. The projector 100 generates drawing data that is data of a line image corresponding to a trajectory of the detected indication positions, and displays the generated drawing data on the projection surface 7.

The information processing device 200 is a source that supplies the image signal to the projector 100. Examples of the information processing device 200 include a desktop, notebook, or tablet personal computer, and a smartphone. A document camera may be coupled instead of one of the information processing device 200A and the information processing device 200B coupled to the projection system 1.

### 2. Configuration of Projector

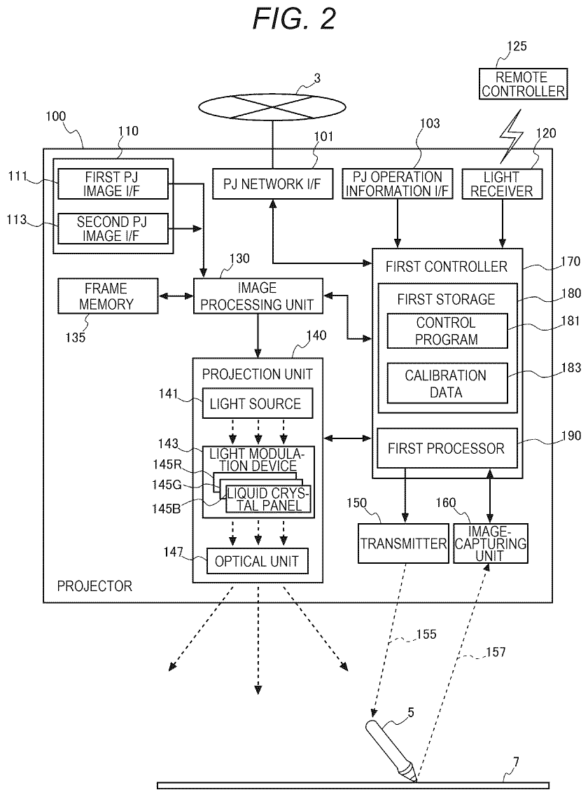

FIG. 2 is a block diagram illustrating a configuration of the projector 100.

The configuration of the projector 100 will be described with reference to FIG. 2.

The projector 100 includes a PJ network interface 101, a PJ operation information interface 103, a PJ image interface 110, a light receiver 120, an image processing unit 130, a frame memory 135, a projection unit 140, a transmitter 150, the image-capturing unit 160, and a first controller 170. Hereinafter, an interface is also referred to as an I/F.

The PJ network I/F 101 includes, for example, a communication card such as a network interface card (NIC), and performs data communication with the information processing device 200 via the communication network 3.

The PJ operation information I/F 103 corresponds to a coupler. The PJ operation information I/F 103 is, for example, an interface such as a USB port. The PJ operation information I/F 103 includes a connector to which the operation information transfer cable 11 is coupled, and an interface circuit that transmits the operation information output via the operation information transfer cable 11. The PJ operation information I/F 103 outputs the operation information generated by the first controller 170 to the information processing device 200B. In the embodiment, the description will be given on the assumption that the PJ operation information I/F 103 is a USB port interface.

The PJ image I/F 110 includes a first PJ image I/F 111 and a second PJ image I/F 113. The PJ image I/F 110 corresponds to the coupler. The first PJ image I/F 111 corresponds to a first coupler. The second PJ image I/F 113 corresponds to a second coupler. The first PJ image I/F 111 and the second PJ image I/F 113 are image interfaces such as HDMI or a display port. In the embodiment, the description will be given on the assumption that the first PJ image I/F 111 and the second PJ image I/F 113 are HDMI interfaces. The first PJ image I/F 111 and the second PJ image I/F 113 may be image interfaces of different standards.

Each of the first PJ image I/F 111 and the second PJ image I/F 113 includes a connector to which the image cable 10 is coupled and an interface circuit that receives the image signal input via the image cable 10. The first PJ image I/F 111 and the second PJ image I/F 113 extract the image data included in the input image signal. The first PJ image I/F 111 and the second PJ image I/F 113 output the extracted image data to the image processing unit 130.

In the embodiment, the description will be given on the assumption that the information processing device 200A is coupled to the first PJ image I/F 111 and the information processing device 200B is coupled to the second PJ image I/F 113.

The light receiver 120 receives an infrared signal transmitted from a remote controller 125. The light receiver 120 outputs an operation signal corresponding to the received infrared signal to the first controller 170. The operation signal is a signal corresponding to an operated switch of the remote controller 125.

The frame memory 135 is coupled to the image processing unit 130. The frame memory 135 includes a plurality of banks. Each of the banks has a storage capacity that enables the writing of image data for one frame. The frame memory 135 is implemented by, for example, a synchronous dynamic RAM (SDRAM). The image processing unit 130 loads the image data input from the PJ image I/F 110 onto the frame memory 135.

The image processing unit 130 performs image processing on the image data loaded onto the frame memory 135. Examples of the image processing performed by the image processing unit 130 include resolution conversion processing, resizing processing, distortion aberration correction, shape correction processing, digital zoom processing, and adjustment of an image color tone and luminance. The image processing unit 130 executes processing designated by the first controller 170, and executes the processing by using a parameter input from the first controller 170 as necessary. The image processing unit 130 can of course execute a combination of the plurality of pieces of the image processing described above. When the image processing ends, the image processing unit 130 reads the data loaded on the frame memory 135 as display data and outputs the read display data to a panel driving unit of a light modulation device 143. The illustration of the panel driving unit is omitted.

The image processing unit 130 and the frame memory 135 are implemented by, for example, an integrated circuit. Examples of the integrated circuit include a large scale integration (LSI), an application specific integrated circuit (ASIC), a programmable logic device (PLD), a field-programmable gate array (FPGA), and a system-on-a-chip (SoC). An analog circuit may be included in a part of a configuration of the integrated circuit, and the first controller 170 and the integrated circuit may be combined.

The projection unit 140 includes a light source 141, the light modulation device 143, and an optical unit 147.

The light source 141 includes a discharge-type light source lamp such as an extra-high pressure mercury lamp or a metal halide lamp, or a solid light source such as a light-emitting diode or a semiconductor laser. Light emitted from the light source 141 is separated into red light, green light, and blue light by a color separation optical system (not illustrated).

The light modulation device 143 includes three liquid crystal panels 145R, 145G, and 145B corresponding to red, green, and blue color components. Hereinafter, the liquid crystal panels 145R, 145G, and 145B are collectively referred to as a liquid crystal panel 145. The color light separated into the red, green, and blue color components by the color separation optical system is incident on the liquid crystal panels 145R, 145G, and 145B, respectively.

Each of the liquid crystal panels 145R, 145G, and 145B is implemented by a transmissive liquid crystal panel in which liquid crystal is sealed between a pair of transparent substrates. In the liquid crystal panel, a pixel area formed of a plurality of pixels arranged in a matrix shape is formed, and a drive voltage can be applied to the liquid crystal for each pixel.

The light modulation device 143 includes the panel driving unit that drives the liquid crystal panels 145R, 145G, and 145B. The panel driving unit applies a drive voltage corresponding to the display data input from the image processing unit 130 to each pixel in the pixel area and sets each pixel to a light transmittance corresponding to the display data. The light emitted from the light source 141 is modulated for each pixel by passing through the pixel area of the liquid crystal panel 145, and image light corresponding to the display data is formed for each color light. The formed image light of each color is combined for each pixel by a color-combining optical system (not illustrated) to become image light representing a color image. The optical unit 147 includes a projection lens and enlarges and projects the image light modulated by the liquid crystal panel 145 onto the projection surface 7. Accordingly, a projection image based on the image data is displayed on the projection surface 7.

The transmitter 150 includes, for example, light source such as a light emitting diode (LED) and a device that controls turning on and turning off of the light source. The device that performs control can be implemented by, for example, an ASIC, an FPGA, or the like.

The transmitter 150 transmits first signal light 155 that is a signal for synchronizing a light emission timing of the indicator 5 with an image-capturing timing of the image-capturing unit 160. The first signal light 155 is a near-infrared light signal that can be received by the indicator 5. The transmitter 150 periodically transmits the first signal light 155 while the projector 100 is in operation.

The first signal light 155 is a control signal indicating a timing of causing the indicator 5 to transmit the first signal light 155. The first signal light 155 is near-infrared light having a predetermined light emission pattern. For example, the indicator 5 emits second signal light 157 in synchronization with a timing at which the first signal light 155 is received. The projector 100 causes the image-capturing unit 160 to execute image capturing at a timing at which the indicator 5 emits the second signal light 157.

The image-capturing unit 160 is a camera including an image-capturing element (not illustrated) such as a charge coupled device (CCD) sensor or a complementary metal oxide semiconductor (CMOS) sensor. The image-capturing unit 160 includes an infrared transmission filter that absorbs visible light and transmits infrared light, and captures an image of the infrared light emitted from the indicator 5 via the infrared transmission filter. The image-capturing unit 160 repeats capturing images of the projection surface 7 under the control of the first controller 170 and sequentially outputs the captured images, which are image-capturing results, to the first controller 170.

The first controller 170 is a computer device including a first storage 180 and a first processor 190.

The first storage 180 includes a memory such as a random access memory (RAM) and a read only memory (ROM). The RAM is used to temporarily store various types of data and the like. The ROM stores control programs for controlling operations of the projector 100, various types of setting information, and the like.

The first storage 180 stores a control program 181 and calibration data 183.

The control program 181 is a program such as firmware or an application program executed by the first processor 190.

The calibration data 183 is data that associates coordinates of the captured image of the image-capturing unit 160 with coordinates of the frame memory 135. A two-dimensional coordinate system is set in the captured image and the frame memory 135, and the coordinates of the frame memory 135 corresponding to the coordinates on the captured image are uniquely specified by the calibration data 183.

The first processor 190 is an arithmetic processing device implemented by a central processing unit (CPU) or a micro processing unit (MPU). The first processor 190 executes the control program 181 to control each unit of the projector 100. The first processor 190 may be implemented by a single processor or a plurality of processors. The first processor 190 may be implemented by a SoC integrated with a part or all of the first storage 180 or with other circuits. The first processor 190 may be implemented by a combination of a CPU that executes a program and a DSP that executes predetermined arithmetic processing. The first processor 190 may be implemented by implementing all of the functions thereof in hardware, or may be implemented using a programmable device.

The first controller 170 detects the infrared light emitted by the indicator 5 from the captured image input from the image-capturing unit 160. The first controller 170 considers an infrared light image included in the captured image that has a brightness equal to or larger than a predetermined threshold and a size within a predetermined range to be light emitted by the indicator 5. The first controller 170 detects the indication position of the indicator 5 based on the position of the light emitted by the indicator 5 in the captured image. The first controller 170 determines the light emission sequence of the indicator 5 based on the captured images acquired a plurality of times and detects the presence or absence of a touch on the projection surface 7.

In a PJ interactive mode, the first controller 170 generates the drawing data in which a line is drawn along the trajectory of the indication position based on a detection result of the indication position. For example, when a user performs a drawing operation of drawing on the projection surface 7 with the indicator 5, that is, when the indication position changes in a state where the indicator 5 is in touch with the projection surface 7, the first controller 170 generates the drawing data based on the trajectory of the indication position.

The generated drawing data is output to the image processing unit 130. The image processing unit 130 superimposes the drawing data on the frame memory 135 on which the image data is loaded, and outputs the data loaded on the frame memory 135 to the panel driving unit of the light modulation device 143 as the display data.

In contrast, in a PC interactive mode, the first controller 170 outputs operation information, which is the detection result of the indication position, to the information processing device 200B via the PJ operation information I/F 103. In the information processing device 200B, for example, when an APP is activated, the information processing device 200B generates, according to the input operation information, the drawing data in which a line is drawn along the trajectory of the indication position.

The information processing device 200B superimposes the generated drawing data on the image data supplied to the projector 100 to generate superimposed image data. The information processing device 200B transmits an image signal including the generated superimposed image data to the projector 100 via a PC image I/F 205B.

The projector 100 receives the image signal transmitted from the information processing device 200B with the second PJ image I/F 113. The second PJ image I/F 113 extracts the superimposed image data included in the received image signal and outputs the extracted superimposed image data to the image processing unit 130. The image processing unit 130 loads the input superimposed image data on the frame memory 135 and performs the image processing on the loaded superimposed image data. The image processing unit 130 outputs the data after the image processing to the panel driving unit of the light modulation device 143 as the display data. The projection unit 140 generates the image light based on the display data and projects the generated image light on the projection n surface 7. Accordingly, a superimposed image in which the drawing data is superimposed on the image data is displayed on the projection surface 7.

### 3. Configuration of Information Processing Device

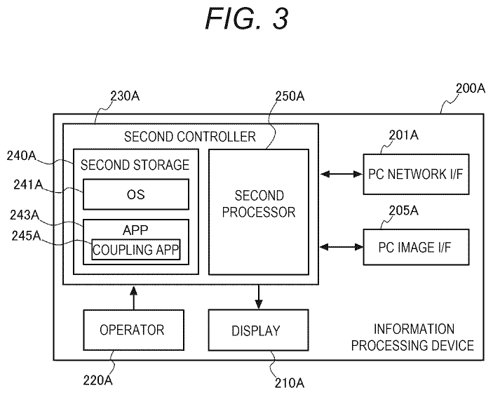

FIG. 3 is a block diagram illustrating a configuration of the information processing device 200A.

The information processing device 200A includes a PC network I/F 201A, a PC image I/F 205A, a display 210A, an operator 220A, and a second controller 230A.

The PC network I/F 201A includes, for example, a communication card such as an NIC, and performs data communication with the projector 100 via the communication network 3.

The PC image I/F 205A is, for example, an image interface such as a HDMI or a display port. In the embodiment, the description will be given on the assumption that the PC image I/F 205A is an HDMI interface.

The PC image I/F 205A includes a connector to which the image cable 10 is coupled and an interface circuit that receives the image signal input via the image cable 10.

The display 210A includes, for example, a display panel such as a liquid crystal panel or an organic electro luminescence (EL) panel, and displays an image based on image data input from the second controller 230A on the display panel. The display 210A may be implemented by a touch panel.

The operator 220A includes an input device such as a mouse or a keyboard, and receives operations of the user. The operator 220A outputs an operation signal corresponding to the received operation to the second controller 230A. When the operation signal is input from the operator 220A, the second controller 230A determines that an operation is received.

The second controller 230A is a computer device including a second storage 240A and a second processor 250A.

The second storage 240A includes a volatile memory such as an RAM and a nonvolatile memory such as an ROM. The second storage 240A includes an auxiliary storage device such as a solid state drive (SSD) or a hard disk drive (HDD).

The second storage 240A stores an operating system (OS) 241A executed by the second processor 250A and a control program such as an application program 243A. The application program 243A is hereinafter referred to as an APP 243A. The APP 243A includes a coupling APP 245A for controlling the coupling between the information processing device 200 and the projector 100.

The second processor 250A is an arithmetic processing device implemented by a CPU or an MPU. The second processor 250A may be implemented by a single processor or a plurality of processors. The second processor 250A may be implemented by an SoC integrated with a part or all of the second storage 240A or with other circuits. The second processor 250A may be implemented by a combination of a CPU that executes a program and a DSP that executes predetermined arithmetic processing. The second processor 250A may be implemented by implementing all of the functions thereof in hardware, or may be implemented using a programmable device.

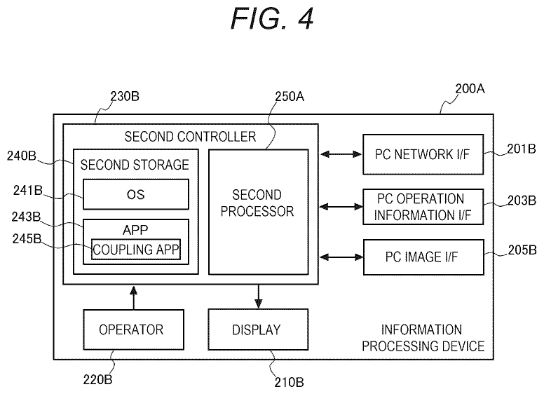

FIG. 4 is a block diagram illustrating a configuration of the information processing device 200B. Hereinafter, a configuration of the information processing device 200B different that from of the information processing device 200A will be described, and a description of the same configuration as that of the information processing device 200A will be omitted.

A PC operation information I/F 203B includes a connector to which the operation information transfer cable 11 is coupled, and an interface circuit that receives the drawing data input via the operation information transfer cable 11.

4. Operations of Projector and Information Processing Device during Coupling

Hereinafter, the information processing device 200A and the information processing device 200B are referred to as the information processing device 200 without being distinguished from each other except when the information processing device 200A and the information processing device 200B need to be distinguished from each other.

As operation modes, the projector 100 has two modes including the PJ interactive mode as a first operation mode and a PC interactive mode as a second operation mode.

The PJ interactive mode is a mode in which the projector 100 generates the operation information based on the indication position of the indicator 5 and the projector 100 generates the drawing data based on the generated operation information.

The PC interactive mode is a mode in which the projector 100 generates the operation information based on the indication position of the indicator 5 and outputs the generated operation information to the information processing device 200.

In the PJ interactive mode, for example, processing of displaying a pointer or a menu bar on the projection surface 7 to follow the indication position of the indicator 5 and moving a display position by the projector 100 is executed. The projector 100 generates the drawing data corresponding to the trajectory of the indication position based on the coordinates of the indication position and executes processing of displaying the generated drawing data on the projection surface 7.

In the PC interactive mode, coordinate data output by the projector 100 is treated in the same way as coordinate data output by a general-purpose pointing device. Accordingly, an indication operation by the indicator 5 is processed as an operation of the pointing device by using a general-purpose device driver program installed in advance as a part of the functions of the OS of the information processing device 200.

For example, the processing of displaying a pointer or a menu bar to follow the indication position of the indicator 5 and moving the display position can be executed. When the information processing device 200 executes a dedicated device driver program corresponding to the projector 100, a unique function can be implemented in addition to the function provided by the OS of the information processing device 200. For example, it is possible to control the operation of the projector 100 based on the indication operation by the indicator 5 to start and end execution of a specific function (an AV mute function, a multi-screen display function, or the like), perform control during the execution of the function, and the like. This unique function can be freely set according to the specifications of the dedicated device driver program.

The projector 100 determines the switching of the operation modes between the PJ interactive mode and the PC interactive mode based on application information acquired from the information processing device 200 coupled to the PJ image I/F 110.

When the projector 100 acquires the application information for identifying a coupling APP 245 executed by the information processing device 200, the projector 100 sets the operation mode to the PC interactive mode. That is, when the operation mode of the projector 100 before the information processing device 200 is coupled is the PJ interactive mode, the operation mode is changed from the PJ interactive mode to the PC interactive mode.

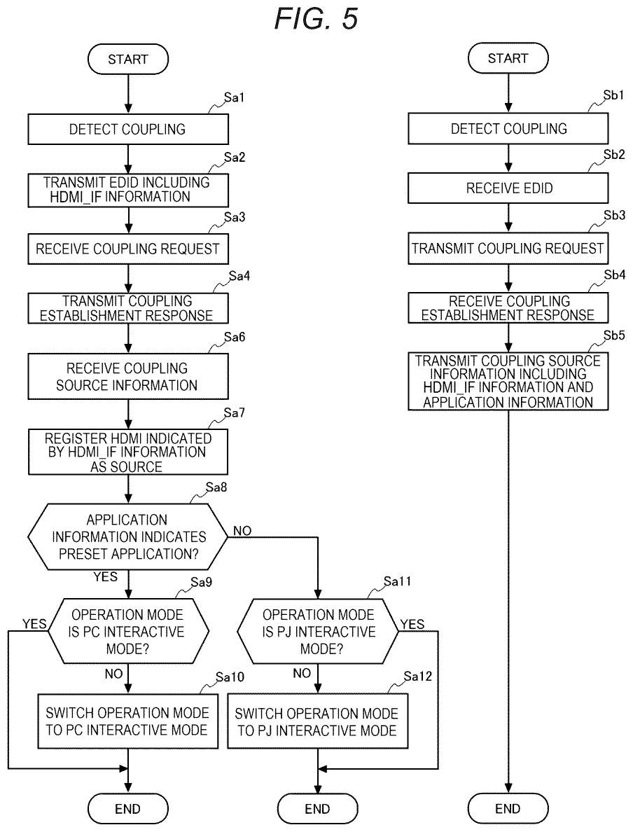

FIG. 5 is a flowchart illustrating the operations of the projector 100 and the information processing device 200 at the time of coupling.

First, the first controller 170 of the projector 100 detects coupling to the PJ image I/F 110 (step Sa1). A second controller 230 of the information processing device 200 also detects coupling to a PC image I/F 205 (step Sb1). The first controller 170 detects the coupling to the PJ image I/F 110 when a hot plug detect (HPD) signal is input, and the second controller 230 detects the coupling to the PC image I/F 205 when an HPD signal is input.

Next, the first controller 170 transmits an extended display identification data (EDID) signal including HDMI_IF information indicating an interface of the PJ image I/F 110 for which the coupling is detected to the information processing device 200 (step Sa2). The second controller 230 receives the EDID signal transmitted by the projector 100 (step Sb2).

When receiving the EDID signal, the second controller 230 executes the coupling APP 245 and transmits a coupling request to the projector 100 (step Sb3). The first controller 170 receives the coupling request transmitted from the information processing device 200 (step Sa3).

When receiving the coupling request, the first controller 170 executes coupling establishment processing of coupling to the information processing device 200 via the communication network 3 to enable mutual data communication. When the coupling establishment processing ends, the first controller 170 transmits a coupling establishment response to the information processing device 200 (step Sa4).

When receiving the coupling establishment response from the projector 100 (step Sb4), the second controller 230 transmits coupling source information to the projector 100 under the control of the coupling APP 245 (step Sb5). The coupling source information includes the HDMI_IF information included in the EDID received in step Sb2 and the application information for identifying the coupling APP 245.

The first controller 170 receives the coupling source information transmitted from the information processing device 200 (step Sa6). The first controller 170 acquires the HDMI_IF information included in the received coupling source information. The first controller 170 registers an HDMI interface of the PJ image I/F 110 indicated by the acquired HDMI_IF as a source to which the image signal is input (step Sa7).

Next, the first controller 170 acquires the application information included in the coupling source information. The first controller 170 determines whether the acquired application information is application information on a preset coupling APP 245 (step Sa8).

When the acquired application information is the application information on the coupling APP 245 (YES in step Sa8), the first controller 170 determines whether the operation mode of the projector 100 is the PC interactive mode (step Sa9).

When the operation mode of the projector 100 is the PC interactive mode (YES in step Sa9), the first controller 170 ends the processing flow. When the operation mode of the projector 100 is not the PC interactive mode (NO in step Sa9), the first controller 170 changes the operation mode of the projector 100 to the PC interactive mode (step Sa10).

When the acquired application information is not the application information on the coupling APP 245 (NO in step Sa8), the first controller 170 determines whether the operation mode of the projector 100 is the PJ interactive mode (step Sa11).

When the operation mode of the projector 100 is the PJ interactive mode (YES in step Sa11), the first controller 170 ends the processing flow. When the operation mode of the projector 100 is not the PJ interactive mode (NO in step Sa11), the first controller 170 changes the operation mode of the projector 100 to the PJ interactive mode (step Sa12).

In the above-described embodiment, a case has been described in which the projector 100 changes the operation mode of the projector 100 based on the application information acquired from the information processing device 200. As another operation, the operation mode of the projector 100 may be changed depending on whether the projector 100 acquires the application information from the information processing device 200. That is, when the second controller 230 executes the coupling APP 245, the coupling APP 245 transmits the application information to the projector 100. When acquiring the application information from the information processing device 200, the first controller 170 sets the operation mode of the projector 100 to the PC interactive mode. When the first controller 170 cannot acquire the application information from the information processing device 200, the first controller 170 sets the operation mode of the projector 100 to the PJ interactive mode.

### 5. Operation of Projector During Source Switching

When the first controller 170 sets the operation mode of the projector 100 to the PC interactive mode, the first controller 170 sets an output destination of the operation information generated by the projector 100 based on the indication position of the indicator 5 to the information processing device 200 for which the coupling establishment processing is executed.

When the first controller 170 sets the operation mode of the projector 100 to the PJ interactive mode, the first controller 170 generates the drawing data based on the operation information generated by the projector 100 based on the indication position of the indicator 5.

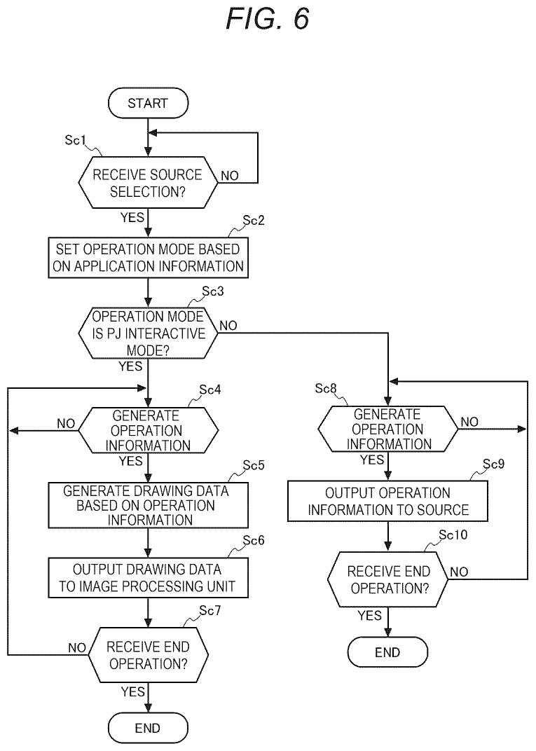

FIG. 6 is a flowchart illustrating operations of the projector 100 at the time of source switching. The operations of the projector 100 will be described with reference to the flowchart illustrated in FIG. 6.

First, the first controller 170 determines whether an operation of source selection is received by the remote controller 125 (step Sc1). When not receiving the operation of source selection (NO in step Sc1), the first controller 170 waits until the operation of source selection is received.

When receiving the operation of source selection by the remote controller 125 (YES in step Sc1), the first controller 170 sets the operation mode of the projector 100 (step Sc2). The first controller 170 sets the operation mode of the projector 100 based on the application information acquired from the information processing device 200, which is a source selected by the source selection, at the time of coupling (step Sc2). That is, when the application information indicates the preset coupling APP 245, the first controller 170 sets the operation mode to the PC interactive mode. When the application information does not indicate the coupling APP 245 or when the application information cannot be acquired, the first controller 170 sets the operation mode to the PJ interactive mode.

For example, when the first PJ image I/F 111, which is the first coupler, is selected, the first controller 170 switches the operation mode based on the application information acquired from the information processing device 200A coupled to the first PJ image I/F 111.

Next, the first controller 170 determines whether the operation mode of the projector 100 set in step Sc2 is the PJ interactive mode (step Sc3).

When the operation mode of the projector 100 is the PJ interactive mode (YES in step Sc3), the first controller 170 detects the operation of the indicator 5 and determines whether the operation information is generated (step Sc4). When the first controller 170 detects the operation of the indicator 5 and does not generate the operation information (NO in step Sc4), the first controller 170 waits until the operation information is generated.

When the operation information is generated (YES in step Sc4), the first controller 170 generates the drawing data based on the generated operation information (step Sc5). The first controller 170 outputs the generated drawing data to the image processing unit 130 (step Sc6) and superimposes the drawing data on the image data loaded on the frame memory 135. The image processing unit 130 reads the data loaded on the frame memory 135 as the display data and outputs the display data to the panel driving unit of the light modulation device 143. Accordingly, the projection image based on the image data and the drawing data is displayed on the projection surface 7.

Next, the first controller 170 determines whether an end operation is received (step Sc7). When the end operation is not received (NO in step Sc7), the first controller 170 returns to the determination in step Sc4. When the end operation is received (YES in step Sc7), the first controller 170 ends the processing flow.

Next, in step Sc3, an operation when the operation mode of the projector 100 is the PC interactive mode will be described.

When the operation mode of the projector 100 set in step Sc2 is the PC interactive mode (NO in step Sc3), the first controller 170 detects the operation of the indicator 5 and determines whether the operation information is generated (step Sc8). When the operation of the indicator 5 is detected and the operation information is not generated (NO in step Sc8), the first controller 170 waits until the operation information is generated.

When the operation information is generated (YES in step Sc8), the first controller 170 outputs the generated operation information to the information processing device 200, which is a source (step Sc9). Next, the first controller 170 determines whether the end operation is received (step Sc10). When the end operation is not received (NO in step Sc10), the first controller 170 returns to the determination in step Sc8. When the end operation is received (YES in step Sc10), the first controller 170 ends the processing flow.

### 6. Second Embodiment

A second embodiment is an embodiment in which the projector 100 and the information processing device 200 are coupled to the communication network 3, and the projector 100 and the information processing device 200 transmit and receive an image signal and data via the communication network 3. That is, a difference from the first embodiment is that the projector 100 and the information processing device 200 are not coupled by the image cable 10.

Also in the embodiment, the projector 100 switches operation modes of the projector 100 to a PJ interactive mode or a PC interactive mode based on application information acquired from the information processing device 200.

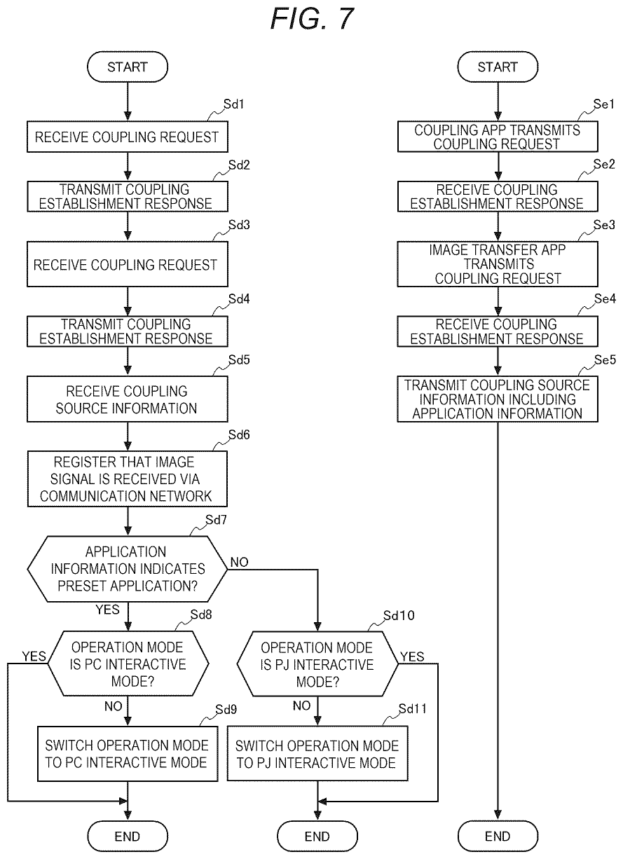

Operations of the projector 100 and the information processing device 200 will be described with reference to a flowchart illustrated in FIG. 7.

First, the second controller 230 executes the coupling APP 245 to transmit a coupling request to the projector 100 coupled to the communication network 3 (step Se1).

The first controller 170 of the projector 100 receives the coupling request via the communication network 3 (step Sd1). The first controller 170 that receives the coupling request executes coupling establishment processing and establishes coupling to enable mutual data communication with the information processing device 200.

After the coupling is established, the first controller 170 transmits a coupling establishment response to the information processing device 200 (step Sd2). The second controller 230 receives the coupling establishment response via the communication network 3 (step Se2).

Next, the second controller 230 executes an APP 243 to transmit an image signal to the projector 100 via the communication network 3. The APP 243 is called an image transfer APP. The second controller 230 that executes the image transfer APP transmits the coupling request to the projector 100 coupled to the communication network 3 (step Se3).

The first controller 170 of the projector 100 receives the coupling request via the communication network 3 (step Sd3). The first controller 170 that receives the coupling request executes the coupling establishment processing and establishes coupling to enable transmission of video from the information processing device 200.

After the coupling is established, the first controller 170 transmits a coupling establishment response to the information processing device 200 (step Sd4). The second controller 230 receives the coupling establishment response via the communication network 3 (step Se4).

Then, the second controller 230 transmits coupling source information to the projector 100 (step Se5). The coupling source information includes transmission of the image signal via the communication network 3 and application information for identifying the coupling APP 245.

The projector 100 receives the coupling source information transmitted from the information processing device 200 (step Sd5). The first controller 170 that receives the coupling source information recognizes that the information processing device 200 transmits the image signal to the projector 100 via the communication network 3. The first controller 170 registers the communication network 3 as a source for receiving the image signal (step Sd6).

Thereafter, the first controller 170 acquires the application information included in the coupling source information. The first controller 170 determines whether the acquired application information is application information on the preset coupling APP 245 (step Sd7).

When the acquired application information is the application information on the coupling APP 245 (YES in step Sd7), the first controller 170 determines whether the operation mode of the projector 100 is the PC interactive mode (step Sd8).

When the operation mode of the projector 100 is the PC interactive mode (YES in step Sd8), the first controller 170 ends the processing flow. When the operation mode of the projector 100 is not the PC interactive mode (NO in step Sd8), the first controller 170 changes the operation mode of the projector 100 to the PC interactive mode (step Sd9).

When the acquired application information is not the application information on the coupling APP 245 (NO in step Sd7), the first controller 170 determines whether the operation mode of the projector 100 is the PJ interactive mode (step Sd10).

When the operation mode of the projector 100 is the PJ interactive mode (YES in step Sd10), the first controller 170 ends the processing flow. When the operation mode of the projector 100 is not the PJ interactive mode (NO in step Sd10), the first controller 170 changes the operation mode of the projector 100 to the PJ interactive mode (step Sd11).

The second embodiment may have a configuration in which the operation mode of the projector 100 is changed depending on whether the projector 100 acquires the application information from the information processing device 200. That is, when the second controller 230 executes the coupling APP 245, the coupling APP 245 transmits the application information to the projector 100. The first controller 170 sets the operation mode of the projector 100 to the PC interactive mode when acquiring the application information from the information processing device 200, and sets the operation mode of the projector 100 to the PJ interactive mode when the application information cannot be acquired from the information processing device 200.

### 7. Third Embodiment

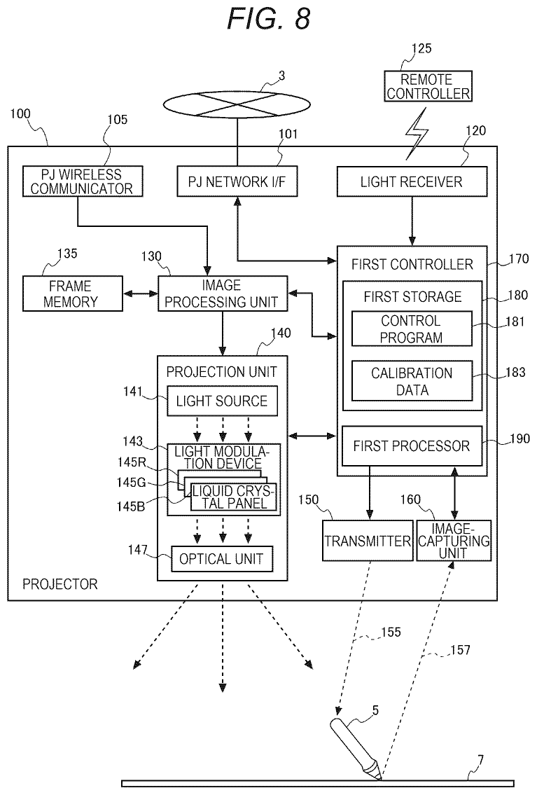

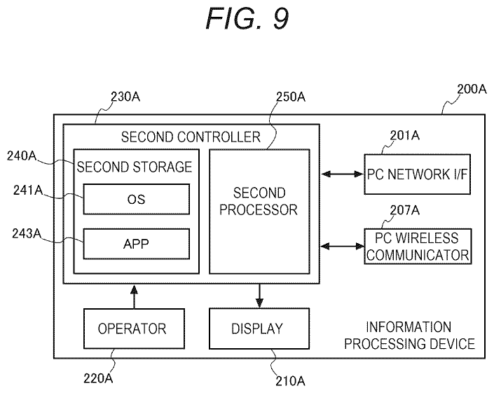

FIG. 8 is a diagram illustrating a configuration of the projector 100 according to a third embodiment. FIG. 9 is a diagram illustrating a configuration of the information processing device 200 according to the third embodiment.

The projector 100 according to the third embodiment differs from the projector 100 according to the first embodiment illustrated in FIG. 2 in that the projector 100 includes a PJ wireless communicator 105 that performs wireless communication.

The information processing device 200 according to the third embodiment differs from the information processing device 200 according to the first embodiment illustrated in FIG. 3 in that the information processing device 200 includes a PC wireless communicator 207A that performs wireless communication.

In the third embodiment, the projector 100 and the information processing device 200 are coupled to the communication network 3, and the projector 100 and the information processing device 200 are connected by wireless communication such as Miracast. Similarly to the second embodiment, the projector 100 and the information processing device 200 are not coupled to each other via the image cable 10. Miracast is a registered trademark.

Also in the embodiment, the projector 100 switches operation modes of the projector 100 to a PJ interactive mode or a PC interactive mode based on application information acquired from the information processing device 200.

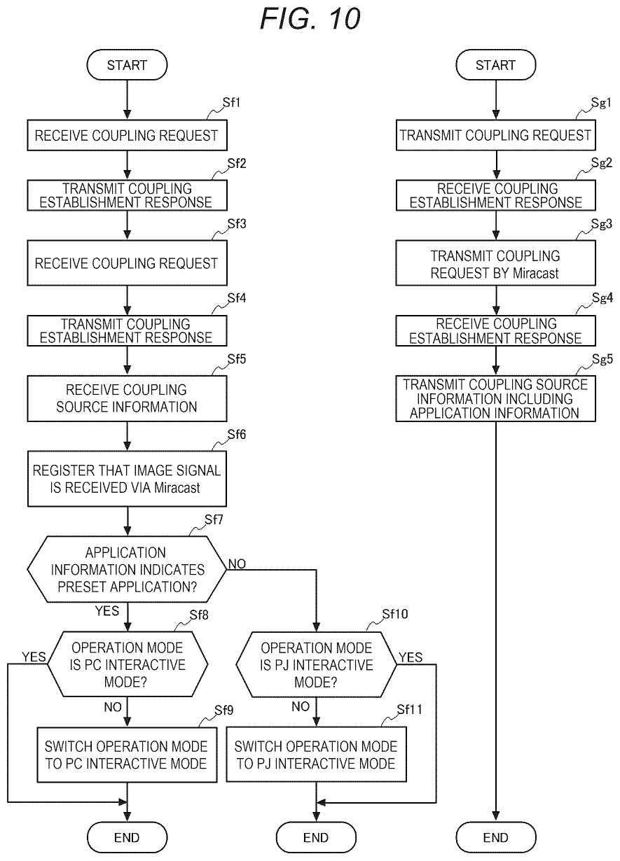

Operations of the projector 100 and the information processing device 200 will be described with reference to a flowchart illustrated in FIG. 10.

First, the second controller 230 that executes the coupling APP 245 transmits a coupling request to the projector 100 coupled to the communication network 3 (step Sg1).

The first controller 170 of the projector 100 receives the coupling request via the communication network 3 (step Sf1). The first controller 170 that receives the coupling request executes coupling establishment processing and establishes coupling to enable mutual data communication with the information processing device 200.

After the coupling is established, the first controller 170 transmits a coupling establishment response to the information processing device 200 (step Sf2). The second controller 230 receives the coupling establishment response via the communication network 3 (step Sg2).

Next, the second controller 230 transmits a coupling request based on Miracast to the projector 100 by the PC wireless communicator 207A (step Sg3).

The first controller 170 receives the coupling request by the PJ wireless communicator 105 (step Sf3). The first controller 170 that receives the coupling request executes the coupling establishment processing and establishes coupling to enable the reception of an image signal transmitted from the information processing device 200.

After the coupling is established, the first controller 170 transmits a coupling establishment response to the information processing device 200 (step Sf4). The second controller 230 receives the coupling establishment response by a PC wireless communicator 207 via the communication network 3 (step Sg4).

Next, the second controller 230 transmits coupling source information including the application information on the coupling APP 245 to the projector 100 (step Sg5). The coupling source information includes transmission of an image signal by Miracast and application information for identifying the coupling APP 245.

The first controller 170 that receives the coupling source information recognizes that the information processing device 200 transmits the image signal to the projector 100 by Miracast. The first controller 170 registers Miracast as a source for receiving the image signal (step Sf6).

Thereafter, the first controller 170 acquires the application information included in the coupling source information. The first controller 170 determines whether the acquired application information is application information on the preset coupling APP 245 (step Sf7).

When the acquired application information is the application information on the coupling APP 245 (YES in step Sf7), the first controller 170 determines whether the operation mode of the projector 100 is the PC interactive mode (step Sf8).

When the operation mode of the projector 100 is the PC interactive mode (YES in step Sf8), the first controller 170 ends the processing flow. When the operation mode of the projector 100 is not the PC interactive mode (NO in step Sf8), the first controller 170 changes the operation mode of the projector 100 to the PC interactive mode (step Sf9).

When the acquired application information is not the application information on the coupling APP 245 (NO in step Sf7), the first controller 170 determines whether the operation mode of the projector 100 is the PJ interactive mode (step Sf10).

When the operation mode of the projector 100 is the PJ interactive mode (YES in step Sf10), the first controller 170 ends the processing flow. When the operation mode of the projector 100 is not the PJ interactive mode (NO in step Sf10), the first controller 170 changes the operation mode of the projector 100 to the PJ interactive mode (step Sf11).

The third embodiment may have a configuration in which the operation mode of the projector 100 is changed depending on whether the projector 100 acquires the application information from the information processing device 200. That is, when the second controller 230 executes the coupling APP 245, the coupling APP 245 transmits the application information to the projector 100. When acquiring the application information from the information processing device 200, the first controller 170 sets the operation mode of the projector 100 to the PC interactive mode. When the first controller 170 cannot acquire the application information from the information processing device 200, the first controller 170 sets the operation mode of the projector 100 to the PJ interactive mode.

### 8. Modification

The above-described embodiments are preferred embodiments according to the present disclosure. However, the present disclosure is not limited to the embodiments described above, and various modified implementations are possible within a range not departing from the gist of the present disclosure.

For example, in the above-described embodiments, the case where the electronic pen is used as the indicator 5 has been described, but the finger of the user may be used as the indicator 5. In this case, it is necessary to separately provide a detection light emitting device that emits detection light for detecting a tip portion of the indicator 5 in a direction including the projection surface 7. Specifically, the detection light emitting device emits the detection light in a planar shape along the projection surface 7. As detection light L emitted by the detection light emitting device, for example, near-infrared light is used.

The functional units of the projector 100 illustrated in FIG. 2 indicate a functional configuration, and a specific implementation form is not particularly limited. The functional units of the information processing device 200 illustrated in FIG. 3 indicate a functional configuration, and a specific implementation form is not particularly limited. That is, there is no need to implement hardware that corresponds to each functional unit individually, and it is of course possible to implement a configuration in which one processor executes a program to implement the functions of a plurality of functional units. In the above-described embodiments, a part of the functions implemented by software may be implemented by hardware, and a part of the functions implemented by hardware may be implemented by software. In addition, specific detailed configurations of the other units of the projector 100 and the information processing device 200 can be freely changed without departing from the gist of the present disclosure.

Processing units of the flowcharts illustrated in FIGS. 5 to 7 and 10 are divided according to main processing contents to facilitate understanding of the processing performed by the projector 100 and the information processing device 200. The present disclosure is not limited by the division method or names of processing units illustrated in the flowcharts in FIGS. 5 to 7 and 10. The processing performed by the projector 100 and the information processing device 200 may be divided into more processing units according to the processing contents, or may be divided such that one processing unit includes more processing. The processing order of the flowchart described above is not limited to the illustrated examples.

In the above-described embodiments, the liquid crystal panel 145 included in the light modulation device 143 may be a transmissive-type liquid crystal panel or may be a reflective-type liquid crystal panel. The light modulation device 143 may include a digital mirror device, or may include a combination of a digital mirror device and a color wheel. The light modulation device 143 may adopt a configuration capable of modulating the light emitted by the light source other than the liquid crystal panel and the DMD.

When the mode switching method for the projector is implemented using a computer included in the projector 100, programs to be executed by the computer may be implemented in a form of a recording medium. Alternatively, the programs to be executed by the computer can also be implemented in a form of a transmission medium for transmitting the programs. As the recording medium, a magnetic or optical recording medium or a semiconductor memory device can be used. Specific examples of the recording medium include portable or immobile recording media such as a flexible disc, a hard disk drive (HDD), a CD-ROM, a digital versatile disc (DVD), a Blu-ray disc, a magneto-optical disk, a flash memory, and a card-shaped recording medium. The recording medium may be a nonvolatile storage device such as a RAM, a ROM, or an HDD which is an internal storage device provided in a server device. Blu-ray is a registered trademark.

In the above-described embodiments, the information processing device 200 may be a document camera. However, for example, when the information processing device 200A according to the first embodiment is replaced with a document camera, the PC network I/F 201A may be omitted.

### 9. Summary of Present Disclosure

The present disclosure will be summarized below in the form of appendixes.

### APPENDIX 1

A mode switching method for a projector configured to project an image onto a projection surface, the mode switching method including: detecting, by the projector, that an information processing device is coupled to a coupler included in the projector; acquiring, by the projector, application information for identifying an application program that operates in the information processing device from the information processing device; and switching, based on the application information, an operation mode of the projector to a first operation mode in which operation information on an operation received by the projector is processed by the projector or a second operation mode in which the operation information is transmitted to the information processing device via a data communication line.

Accordingly, when the projector detects that the information processing device is coupled to the coupler of the projector, the projector acquires the application information for identifying the application program that operates in the information processing device from the information processing device. The projector switches the operation mode of the projector to the first operation mode or the second operation mode based on the acquired application information. Therefore, it is possible to change the operation mode of the projector by the application program that operates in the information processing device, and it is possible to improve user convenience.

### APPENDIX 2

The mode switching method according to Appendix 1, in which the information processing device includes a first information processing device and a second information processing device, the projector includes, as the coupler, a first coupler configured to be coupled to the first information processing device and a second coupler configured to be coupled to the second information processing device, and the mode switching method further includes: receiving, by the projector, selection of one of the first coupler and the second coupler as a supply source of image data, and switching, by the projector, the operation mode of the projector to the first operation mode or the second operation mode based on the application information acquired from the first information processing device coupled to the selected first coupler or from the second information processing device coupled to the second coupler.

Accordingly, by receiving the selection of one of the first coupler and the second coupler as the supply source of the image data, the application information is acquired from the information processing device coupled to the selected first coupler or second coupler. The operation mode of the projector is switched to the first operation mode or the second operation mode based on the acquired application information. Therefore, even when the coupler for supplying the image data to the projector is switched, the application information is acquired from the information processing device coupled to the switched coupler, and the operation mode of the projector is switched to the first operation mode or the second operation mode based on the acquired application information. Therefore, the user convenience can be improved.

### APPENDIX 3

The mode switching method according to Appendix 2, further including: receiving, by the projector, an operation of selecting the first coupler as a supply source of image data; switching, by the projector, the operation mode to the first operation mode based on the application information acquired from the first information processing device coupled to the selected first coupler; receiving, by the projector, selection of the projector or the second information processing device as an output destination of the operation information; and outputting the operation information to the second information processing device when the selected output destination is the second information processing device.

Accordingly, even when the operation mode of the projector is switched to the first operation mode, the second information processing device can be selected as the output destination of the operation information. Therefore, the user convenience can be improved.

What is claimed is:

1. A mode switching method for a projector configured to project an image onto a projection surface, the mode switching method comprising:
detecting, by the projector, n information processing device is coupled to a coupler included in the projector;
acquiring, by the projector, application information for identifying an application program that operates in the information processing device from the information processing device; and
switching, based on the application information, an operation mode of the projector to a first operation mode in which operation information on an operation received by the projector is processed by the projector or a second operation mode in which the operation information is transmitted to the information processing device via a data communication line.

2. The mode switching method according to claim 1, wherein
the information processing device includes a first information processing device and a second information processing device,
the projector includes, as the coupler, a first coupler configured to be coupled to the first information processing device and a second coupler configured to be coupled to the second information processing device, and
the mode switching method further includes
receiving, by the projector, selection of one of the first coupler and the second coupler as a supply source of image data, and
switching, by the projector, the operation mode of the projector to the first operation mode or the second operation mode based on the application information acquired from the first information processing device coupled to the selected first coupler or from the second information processing device coupled to the second coupler.

3. The mode switching method according to claim 2, further comprising:
receiving, by the projector, an operation of selecting the first coupler as a supply source of image data;
switching, by the projector, the operation mode to the first operation mode based on the application information acquired from the first information processing device coupled to the selected first coupler;
receiving, by the projector, selection of the projector or the second information processing device as an output destination of the operation information; and
outputting the operation information to the second information processing device when the selected output destination is the second information processing device.
